(19) United States
(12) Patent Application Publication
(10) Pub. No.: US 2020/0244688 A1
(43) Pub. Date: Jul. 30, 2020

(54) INFORMATION SELECTION DEVICE, INFORMATION SELECTION METHOD, AND NON-TRANSITORY RECORDING MEDIUM

(71) Applicant: NEC Corporation, Tokyo (JP)

(72) Inventors: Etsuko ICHIHARA, Tokyo (JP); Yoshiaki SAKAE, Tokyo (JP); Shuichi KARINO, Tokyo (JP); Hiroki TAGATO, Tokyo (JP); Kazuhiko ISOYAMA, Tokyo (JP); Yuji KOBAYASHI, Tokyo (JP); Takayoshi ASAKURA, Tokyo (JP)

(73) Assignee: NEC Corporation, Tokyo (JP)

(21) Appl. No.: 16/634,964

(22) PCT Filed: Aug. 7, 2018
(86) PCT No.: PCT/JP2018/029513

§ 371 Date: Jan. 29, 2020

(30) Foreign Application Priority Data
Aug. 9, 2017 (JP) 2017-154627

(51) Int. Cl. H04L 29/06

(52) U.S. Cl. CPC H04L 63/1425; H04L 63/1416

(57) ABSTRACT

Disclosed are an information selection device and the like that make it possible to rapidly acquire information about an event of interest. An information selection device is configured to specify target log information among log information. The log information represents that a process is executed for a processing object in a target system and the target log information represents a processing object that may affect an abnormal process executed in the target system. The information selection device is configured to calculate a frequency of the target log information for each combination of the process with the processing object, calculate an abnormality degree of the target log information based on the calculated frequency and select relevant log information with having the abnormality degree satisfying a condition for determining abnormal log information among the target log information.

### TECHNICAL FIELD

The present invention relates to an information selection device and the like that offers information on events.

### BACKGROUND ART

Ransomware and malware are software having an adverse effect on an information processing system. When an information processing system is attacked by malware or the like, clarifying a procedure or the like by which the malware intrudes into the information processing system allows adoption of measures against malware in addition to preparation of a framework for defending the information processing system from malware. For example, the measures include measures for blocking a communication network or measures for specifying a file being highly likely to be malware. As examples of a device for preparing such a framework, PTL 1 and PTL 2 disclose devices detecting malware. Further, PTL 3 and PTL 4 disclose devices visualizing processes in an information processing system.

PTL 1 discloses a detection device detecting malware. The detection device generates dependence information indicating dependence between function calls made by a program. The detection device compares a pattern indicating the dependence related to a program not being malware with the dependence information.

PTL 2 discloses a detection device detecting malware. The detection device classifies files that may be malware into a plurality of clusters. The detection device selects a typical file belonging to a cluster, statically analyzes the selected file, and, thereby, determines whether or not the selected file includes malware.

PTL 3 discloses an information processing device visualizing a flow of data in an information processing system by representing data processed in the information processing system by use of a graph. Further, PTL 4 discloses an information processing device visualizing relevance between a plurality of events by representing the relevance by use of a graph.

### CITATION LIST

### Patent Literature

PTL 1: Japanese Unexamined Patent Application Publication No. 2017-505944

PTL 2: Japanese Unexamined Patent Application Publication No. 2012-083849

PTL 3: PCT International Publication WO 2015/141220

PTL 4: PCT International Publication WO 2017/094820

### SUMMARY OF INVENTION

### Technical Problem

However, even when any of the devices disclosed in PTL 1 to PTL 4 is used, it is difficult to promptly clarify an event occurring in an information processing system. For example, the device disclosed in PTL 1 or the device disclosed in PTL 2 detects malware but cannot clarify a procedure or the like by which the malware intrudes into an information processing system. Further, the device disclosed in PTL 3 or PTL 4 visualizes an event occurring in an information processing system. As a scale of the information processing system increases, an amount of display information representing the event becomes enormous. However, even when the devices are used, it is difficult to promptly find an event of interest from the display information.

Then, an objective of the present invention is to provide an information selection device or the like capable of promptly acquiring information about an event of interest.

### Solution to Problem

As an aspect of the present invention, an information selection device includes:

target information specification means for specifying target log information among log information, the log information representing that a process is executed for a processing object in a target system, the target log information representing a processing object that may affect an abnormal process executed in the target system;

calculation means for calculating a frequency of the target log information for each combination of the process with the processing object and calculating an abnormality degree of the target log information based on the calculated frequency; and

selection means for selecting relevant log information with having the abnormality degree satisfying a condition for determining abnormal log information among the target log information.

In addition, as another aspect of the present invention, an information selection method includes:

specifying target log information among log information, the log information representing that a process is executed for a processing object in a target system, the target log information representing a processing object that may affect an abnormal process executed in the target system;

calculating a frequency of the target log information for each combination of the process with the processing object and calculating an abnormality degree of the target log information based on the calculated frequency; and

selecting relevant log information with having the abnormality degree satisfying a condition for determining abnormal log information among the target log information.

In addition, as another aspect of the present invention, an information selection program causing a computer to achieve:

a target information specification function for specifying target log information among log information, the log information representing that a process is executed for a processing object in a target system, the target log information representing a processing object that may affect an abnormal process executed in the target system;

a calculation function for calculating a frequency of the target log information for each combination of the process with the processing object and calculating an abnormality degree of the target log information based on the calculated frequency; and

a selection function for selecting relevant log information with having the abnormality degree satisfying a condition for determining abnormal log information among the target log information.

Furthermore, the object is also achieved by a computer-readable recording medium that records the program.

### Advantageous Effects of Invention

The information selection device or the like according to the present invention can promptly acquire information about an event of interest.

### BRIEF DESCRIPTION OF DRAWINGS

FIG. 1 is a block diagram illustrating a configuration of an information selection device according to a first example embodiment of the present invention.

FIG. 2 is a flowchart illustrating a process flow in the information selection device according to the first example embodiment.

FIG. 3 is a diagram conceptually illustrating an example of process information stored in a process information storage unit.

FIG. 4 is a diagram conceptually illustrating an example of communication information stored in a communication information storage unit.

FIG. 5 is a diagram conceptually illustrating an example of file information stored in a file information storage unit.

FIG. 6 is a diagram conceptually illustrating an example of relevance information stored in a relevance information storage unit.

FIG. 7 is a diagram conceptually illustrating an example of graph information stored in a graph information storage unit.

FIG. 8 is a diagram conceptually illustrating an example of log information.

FIG. 9 is a block diagram illustrating a configuration of an information selection device according to a second example embodiment of the present invention.

FIG. 10 is a flowchart illustrating a process flow in the information selection device according to the second example embodiment.

FIG. 11 is a block diagram illustrating a configuration of an information selection device according to a third example embodiment of the present invention.

FIG. 12 is a flowchart illustrating a process flow in the information selection device according to the third example embodiment.

FIG. 13 is a block diagram illustrating a configuration of an information selection device according to a fourth example embodiment of the present invention.

FIG. 14 is a flowchart illustrating a process flow in the information selection device according to the fourth example embodiment.

FIG. 15 is a block diagram schematically illustrating a hardware configuration of a calculation processing device capable of achieving an information selection device according to each example embodiment of the present invention.

### EXAMPLE EMBODIMENT

Next, example embodiments of the present invention will be described in detail with reference to drawings.

### First Example Embodiment

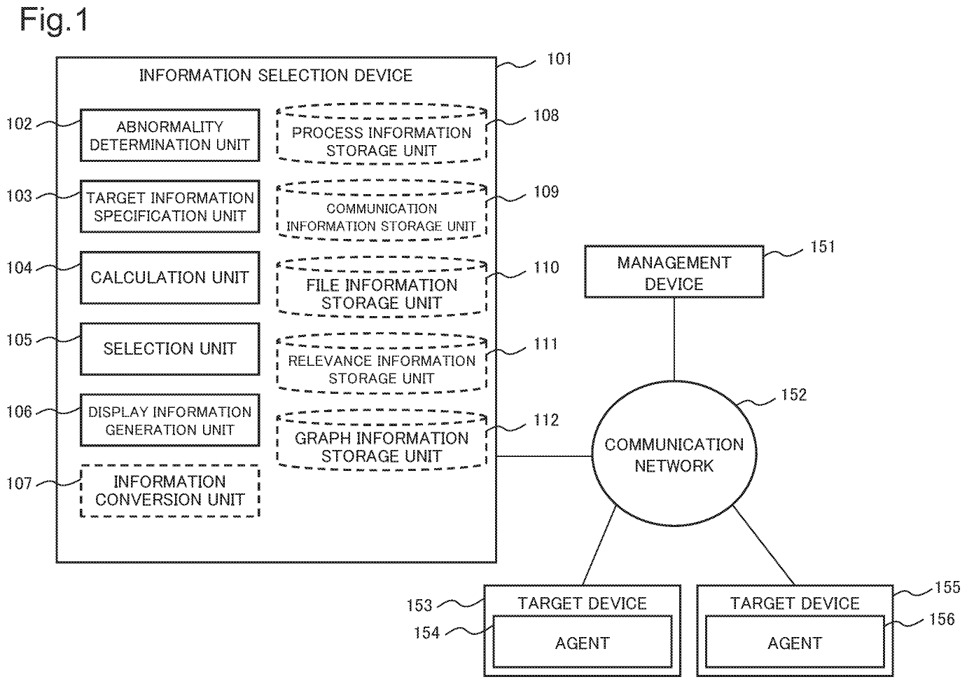

Referring to FIG. 1, a configuration of an information selection device 101 according to a first example embodiment of the present invention will be described in detail. FIG. 1 is a block diagram illustrating a configuration of the information selection device 101 according to the first example embodiment of the present invention.

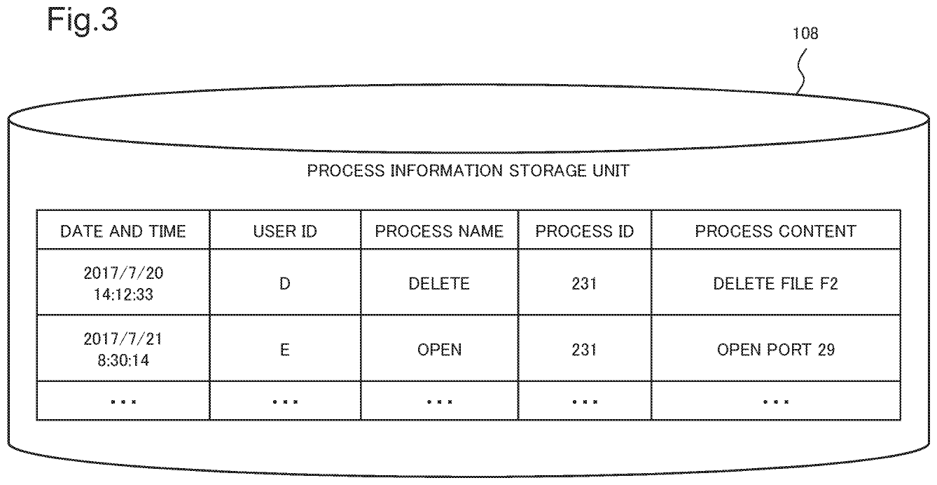

The information selection device 101 according to the first example embodiment includes an abnormality determination unit (abnormality determiner) 102, a target information specification unit (target information specifier) 103, a calculation unit (calculator) 104, and a selection unit (selector) 105. The information selection device 101 may further include a display information generation unit (display information generator) 106 and an information conversion unit (information convertor) 107. The information selection device 101 may include a process information storage unit 108, a communication information storage unit 109, a file information storage unit 110, a relevance information storage unit 111, and a graph information storage unit 112. The process information storage unit 108, the communication information storage unit 109, the file information storage unit 110, the relevance information storage unit 111, and the graph information storage unit 112 will be described later referring to FIG. 3 to FIG. 7, respectively.

The information selection device 101 may be communicably connected to a management device 151 or may be included in the management device 151, and may be communicably connected to target devices (a target device 153 and a target device 155) through a communication network 152. For convenience of description, it is assumed in the following description that the information selection device 101 is communicably connected to the management device 151 through the communication network 152.

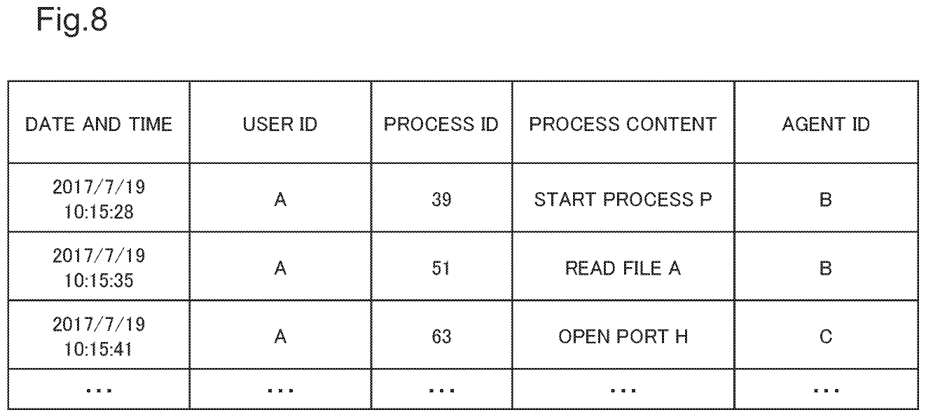

For example, the target device 153 is an information processing device including an agent 154 monitoring a process executed in the own device. Similarly, for example, the target device 155 is an information processing device including an agent 156 monitoring a process executed in the own device. Each of the agent 154 and the agent 156 generates log information representing a content of a process executed in the target device including the agent and transmits the generated log information (exemplified in FIG. 8) to the management device 151 (or the information selection device 101) through the communication network 152. FIG. 8 is a diagram conceptually illustrating an example of log information.

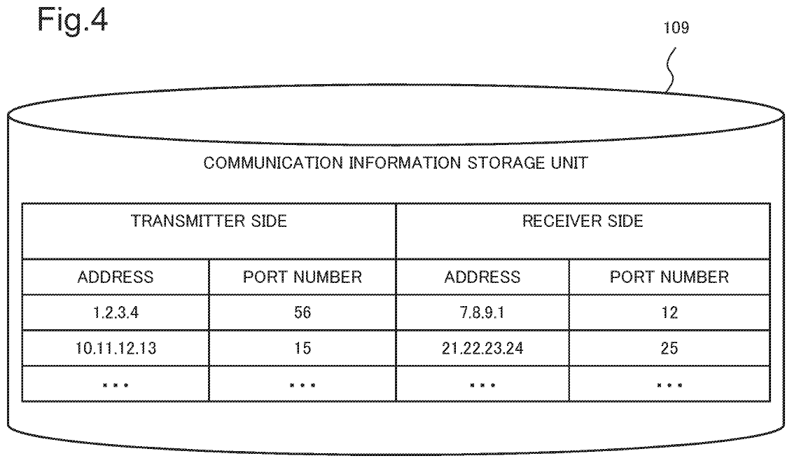

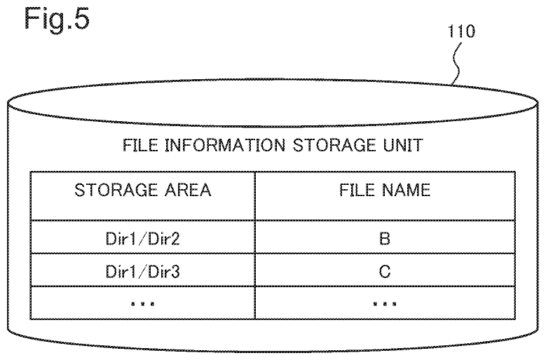

In log information, for example, a process executed in the target device 153 is associated with a date and time of executing the process, a user identifier (an identifier is hereinafter denoted as an “ID”) for identifying a user executing the process, a process ID for identifying the process, and information indicating a process content in the process. In the log information, an agent ID for identifying an agent that generates the log information may be further associated. For example, the process content is process information (to be described later referring to FIG. 3) indicating the process, file information (to be described later referring to FIG. 5) indicating a file accessed in the process, or communication information (to be described later referring to FIG. 4) including socket information indicating a socket accessed in the process (in this case, a communication process).

In the log information exemplified in FIG. 8, for example, a date and time “2017/7/19 10:15:28,” a user ID “A,” a process ID “39,” process content “START PROCESS P,” and an agent ID “B” are associated with one another. The above indicates that a date and time when a process identified by the process ID “39” is executed is “2017/7/19 10:15:28,” a user ID identifying a user that executes the process is “A,” a process being “START PROCESS P” is executed, and an agent identified by the agent ID “B” generates the log information. For example, the management device 151 receives, from an agent identified by the agent ID, log information associated with the agent ID in the log information exemplified in FIG. 8.

For convenience of description, it is hereinafter assumed that the target device 153 and the target device 155 are information processing devices. However, the target device 153 and the target device 155 do not necessarily need to be information processing devices. Further, the target devices may be three or more information processing devices instead of two information processing devices. A system including a plurality of target devices is hereinafter referred to as a “target system.”

The management device 151 receives log information (exemplified in FIG. 8) transmitted by each agent and manages each target device communicably connected through the communication network 152 by monitoring the received log information. The management device 151 transmits the log information or information representing a monitoring result of the log information to, for example, the information selection device 101. For convenience of description, it is assumed in the following description that the information selection device 101 receives log information (exemplified in FIG. 8) from each agent.

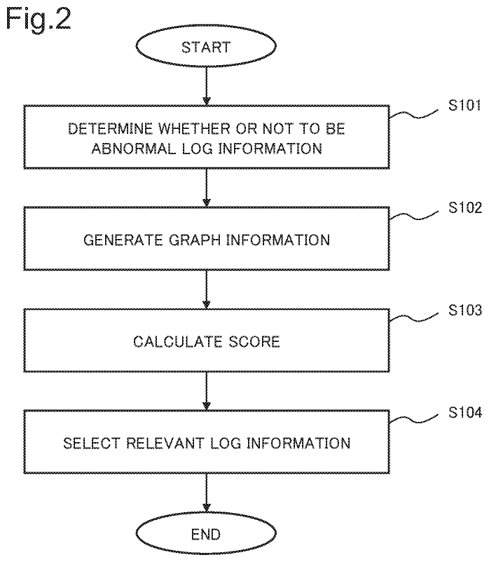

The information selection device 101 receives log information (exemplified in FIG. 8) from each agent and executes a process to be described later referring to FIG. 2, based on the received log information. The information selection device 101 stores each type of information generated in the process to be described later referring to FIG. 2 into the process information storage unit 108, the communication information storage unit 109, the file information storage unit 110, or the relevance information storage unit 111.

Next, referring to FIG. 3 to FIG. 6, each of the process information storage unit 108, the communication information storage unit 109, the file information storage unit 110, and the relevance information storage unit 111 will be described. First, referring to FIG. 3, process information stored in the process information storage unit 108 will be described. FIG. 3 is a diagram conceptually illustrating an example of process information stored in the process information storage unit 108.

Process information is information indicating a process included in log information acquired in a target system including a target device. In the process information exemplified in FIG. 3, a date and time when a process is executed, a user ID identifying a user who executes the process, a process name indicating a name of the process, a process ID identifying the process, and a process content indicating a content of the process are associated with one another. Process information is not limited to the example described above.

In the process information exemplified in FIG. 3, a date and time “2017/7/20 14:12:33,” a user ID “D,” a process name “DELETE,” a process ID “231,” and a process content “DELETE FILE F2” are associated with one another. The above indicates that a user with the user ID “D” executes a process indicated by the process ID “231,” and the process deletes a file “F2” at the date and time “2017/7/20 14:12:33.”

Referring to FIG. 4, communication information stored in the communication information storage unit 109 will be described. FIG. 4 is a diagram conceptually illustrating an example of communication information stored in the communication information storage unit 109.

Communication information is information about a communication process out of processes included in log information acquired in a target system including a target device. For example, in communication information, information indicating a socket through which information transmitted in a communication process passes is associated with socket information indicating a socket through which information received in the communication process passes. The socket information is information in which an address assigned to a target device is associated with a port number used in the target device. Communication information is not limited to the example described above.

In the communication information exemplified in FIG. 4, a target device on the transmitter side is associated with an address “1.2.3.4” and a port number “56.” Further, in the communication information, a target device on the receiver side is associated with an address “7.8.9.1” and a port number “12.” The above indicates a communication process in which information is transmitted from the port number “56” on the target device assigned with the address “1.2.3.4” to the port number “12” on the target device assigned with the address “7.8.9.1.”

Referring to FIG. 5, file information stored in the file information storage unit 110 will be described. FIG. 5 is a diagram conceptually illustrating an example of file information stored in the file information storage unit 110.

File information is information indicating a file accessed in a process included in log information acquired in a target system including a target device. For example, in file information, a storage area indicating an area where a file is stored is associated with a file name indicating a name of the file. In the file information exemplified in FIG. 5, a storage area “Dir1/Dir2” is associated with a file name “B.” The above indicates that a file indicated by the file name “B” is stored in an area indicated by the storage area “Dir1/Dir2.”

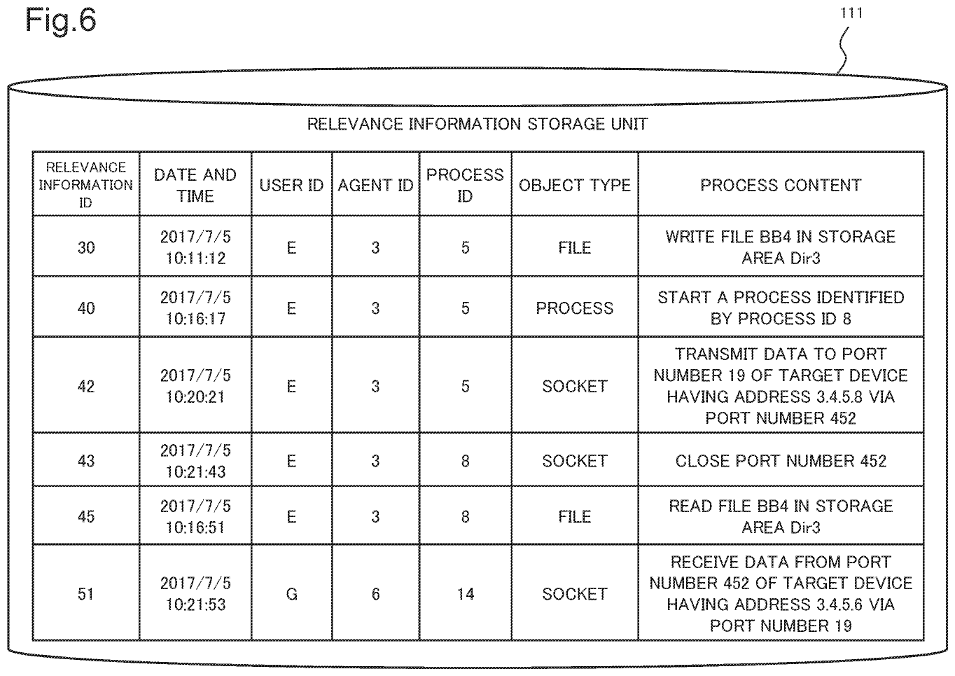

Referring to FIG. 6, relevance information stored in the relevance information storage unit 111 will be described. FIG. 6 is a diagram conceptually illustrating an example of relevance information stored in the relevance information storage unit 111.

Relevance information is information indicating, in processes included in log information acquired in a target system including a target device, a process content of a process performed by the process on a processing object. For example, the processing object is a file, a socket, or another process executed in the processes. In relevance information, a process ID indicating a process is associated with information indicating a process content in the processes. In relevance information, information indicating a date and time when the process is executed, a user ID identifying a user who executes the process, an agent ID identifying an agent generating log information (exemplified in FIG. 8) about the process, relevance information ID for identifying the relevance information, or an object type indicating a type of the processing object may be further associated. Relevance information may be information classified for each object type. Relevance information is not limited to the example described above.

For example, in the relevance information exemplified in FIG. 6, Item 1 to Item 7 described below are associated with one another.

Item 1: RELEVANCE INFORMATION ID “30,”

Item 2: DATE AND TIME “2017/7/5 10:11:12,”

Item 3: USER ID “E,”

Item 4: AGENT ID “3,”

Item 5: PROCESS ID “5,”

Item 6: OBJECT TYPE “FILE,” and

Item 7: PROCESS CONTENT “WRITE INTO FILE BB4 IN STORAGE AREA Dir3.”

The above indicates that a user indicated by the user ID “E” starts a process indicated by the process ID “5” at the date and time “2017/7/5 10:11:12.” Further, the above indicates that an agent identified by the agent ID “3” generates log information about the process and the process is executed on a file (that is, an example of a processing object). Further, the above indicates that the process is a process of “writing into the file BB4 in the storage area Dir3.”

As described above, processes in relevance information (exemplified in FIG. 6) are roughly classified into a process executed on another process and a process executed on a processing object, such as a file or a socket, included in a target device, depending on an object type. For convenience of description, relevance information related to the former is referred to as a “control flow,” and relevance information related to the latter is referred to as a “data flow” in the following description.

The information conversion unit 107 generates process information (exemplified in FIG. 3), communication information (exemplified in FIG. 4), file information (exemplified in FIG. 5), and relevance information (exemplified in FIG. 6) by analyzing log information (exemplified in FIG. 8). For example, the information conversion unit 107 in the information selection device 101 generates file information (exemplified in FIG. 5) indicating information about a file in received log information (exemplified in FIG. 8) and stores the generated file information into the file information storage unit 110. The information conversion unit 107 generates communication information (exemplified in FIG. 4) indicating information about a communication process in received log information (exemplified in FIG. 8) and stores the generated communication information into the communication information storage unit 109. The information conversion unit 107 generates process information (exemplified in FIG. 3) indicating information about a process in received log information (exemplified in FIG. 8) and stores the generated process information into the process information storage unit 108.

When a process is a process performed on a file, the information conversion unit 107 generates relevance information (exemplified in FIG. 6) in which a process ID for identifying the process, a type of the processing object (a “file” in this case), and a file name indicating the file are associated with one another, and stores the generated relevance information into the relevance information storage unit 111. When a process is a communication process related to communication, the information conversion unit 107 generates relevance information (exemplified in FIG. 6) in which a process ID for identifying the process, a type of the processing object (a “socket” in this case), and information indicating the processing object in the communication process are associated with one another, and stores the generated relevance information into the relevance information storage unit 111. When a process is a process executing another process, the information conversion unit 107 generates relevance information (exemplified in FIG. 6) in which a process ID for identifying the process, a type of the processing object (a “process” in this case), and a process ID indicating the other process are associated with one another, and stores the generated relevance information into the relevance information storage unit 111.

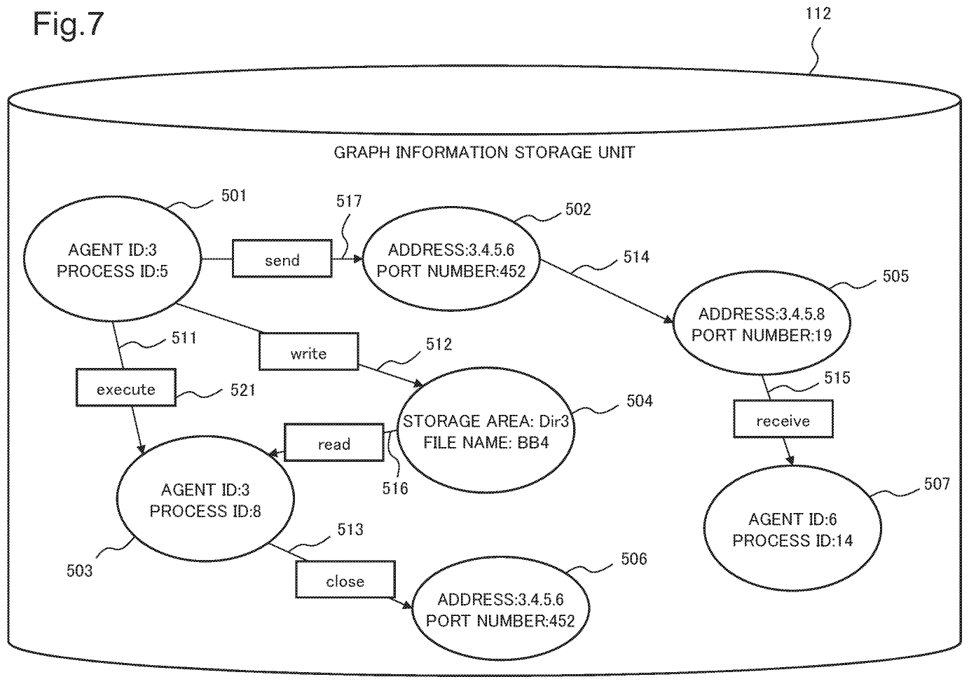

The target information specification unit 103 in the information selection device 101 generates graph information (exemplified in FIG. 7), based on process information (exemplified in FIG. 3), communication information (exemplified in FIG. 4), file information (exemplified in FIG. 5), and relevance information (exemplified in FIG. 6). FIG. 7 is a diagram conceptually illustrating an example of graph information stored in the graph information storage unit 112.

Graph information is information conceptually representing a process executed in a target system including a target device. For example, graph information is information representing a graph including vertices (for example, a vertex 501 to a vertex 507) and edges (for example, an edge 511 to an edge 517). Each vertex corresponds to a processing object. Each edge corresponds to an event of data (or information) transferring between processing objects (hereinafter referred to as a “data transfer”). Each edge according to the present example embodiment is represented by use of a directed edge associating two vertices with each other. A direction of an edge is determined in accordance with a direction of transferring data (or information). Each vertex may be labeled with information about the vertex (illustrated in the vertex). For example, information about a vertex is information for identifying a processing object corresponding to the vertex. Similarly, each edge may be labeled with information about the edge (illustrated in accordance with a mode of being superposed on the edge, such as a label 521). For example, information about an edge is information indicating a process content in a process related to the edge. In FIG. 7, a port number “452” on a target device at an address “3.4.5.6” is expressed by use of the vertex 502 and the vertex 506. While one processing object is expressed by use of two vertices, the above is described for convenience of recognition of the diagram.

Each vertex according to the present example embodiment corresponds to information indicating each process in process information (exemplified in FIG. 3), information indicating each socket in communication information (exemplified in FIG. 4), or information indicating each file in file information (exemplified in FIG. 5). For example, when a process indicated by a process ID is performed on a processing object (a file, a socket, or a process) in relevance information (exemplified in FIG. 6), a vertex corresponding to the process is associated with a vertex representing the processing object by use of an edge.

In the graph information exemplified in FIG. 7, the vertex 501 is given a label being an agent ID “3” and a process ID “5.” This indicates that a process identified by the process ID “5” in log information (exemplified in FIG. 8) generated by an agent identified by the agent ID “3” corresponds to the vertex 501. The vertex 502 is given a label being an address “3.4.5.6” and a port number “452.” This indicates that a socket indicated by the address “3.4.5.6” and the port number “452” corresponds the vertex 502. The vertex 504 is given a label being a storage area “Dir3” and a file name “BB4.” This indicates that a file indicated by the file name “BB4” is stored in the storage area “Dir3” and the file corresponds to the vertex 504.

In the graph information exemplified in FIG. 7, the vertex 501 is associated with the vertex 503 by use of the edge 511. Further, the edge 511 is given a label 521. This indicates that a process corresponding to the vertex 501 executes (label 521) a process corresponding to the vertex 503 and corresponds to a data transfer in a process indicated by relevance information identified by a relevance information ID “40” in the relevance information (exemplified in FIG. 6). In the graph information exemplified in FIG. 7, the vertex 501 is associated with the vertex 504 by use of the edge 512. This indicates that a process corresponding to the vertex 501 writes (a label “write”) into a file corresponding to the vertex 504 and corresponds to a data transfer in a process indicated by relevance information identified by a relevance information ID “30” in the relevance information (exemplified in FIG. 6). In the graph information exemplified in FIG. 7, the vertex 503 is associated with the vertex 506 by use of the edge 513. This indicates that a process corresponding to the vertex 503 closes (a label “close”) a socket corresponding to the vertex 506 and corresponds to a data transfer in a process indicated by relevance information identified by a relevance information ID “43” in the relevance information (exemplified in FIG. 6). Similarly, the edge 514 and the edge 517 in the graph information (exemplified in FIG. 7) correspond to a data transfer in a process indicated by relevance information identified by a relevance information ID “42” in the relevance information (exemplified in FIG. 6). The edge 514 and the edge 515 in the graph information (exemplified in FIG. 7) correspond to a data transfer in a process indicated by relevance information identified by a relevance information ID “51” in the relevance information (exemplified in FIG. 6). The edge 516 in the graph information (exemplified in FIG. 7) corresponds to a data transfer in a process indicated by relevance information identified by a relevance information ID “45” in the relevance information (exemplified in FIG. 6).

For example, each edge may be given a label 1 to a label 9 described below, based on a process content in the relevance information (exemplified in FIG. 6).

Label 1: “execute”: a process executes another process (an edge is directed from “a process” to “another process”),

Label 2: “read”: a process reads a file (an edge is directed from “a file” to “a process”),

Label 3: “write”: a process writes into a file (an edge is directed from “a process” to “a file”),

Label 4: “move”: a process changes a location where a file is stored (an edge is directed from “a process” to “a file”),

Label 5: “delete”: a process deletes a file (an edge is directed from “a process” to “a file”),

Label 6: “open”: a process opens a socket (an edge is directed from “a process” to “a socket”),

Label 7: “close”: a process closes a socket (an edge is directed from “a process” to “a socket”),

Label 8: “send”: a process transmits information through a socket (an edge is directed from “a process” to a “socket”), and

Label 9: “receive”: a process receives information through a socket (an edge is directed from “a socket” to “a process”).

Accordingly, each of the label 2 to the label 5 indicates a process when the process is performed on a file. Each of the label 6 to the label 9 indicates a process when the process is performed on a socket.

A label is not limited to the examples indicated by the label 1 to the label 9. For example, the label 1 may be “start” indicating that a process starts another process and “end” indicating that a process ends another process. For example, a label may be “Create” indicating that a process generates another process.

A label given to an edge may include information indicating a date and time when a process related to the edge is executed. A label given to an edge may include information indicating a user ID for identifying a user who executes a process related to the edge.

For example, a graph represented by the graph information exemplified in FIG. 7 is expressed by use of an adjacency matrix.

Next, referring to FIG. 2, a process in the information selection device 101 according to the first example embodiment of the present invention will be described in detail. FIG. 2 is a flowchart illustrating a process flow in the information selection device 101 according to the first example embodiment. While a flow of the process in the information selection device 101 according to the first example embodiment will be described using technical terms in a graph theory, the process in the information selection device 101 has only to be a process similar to the process to be described referring to FIG. 2.

The abnormality determination unit 102 determines whether or not log information received from a target system is abnormal log information including a process satisfying a predetermined abnormality determination condition (hereinafter referred to as an “abnormal process”) (Step S101). For example, the predetermined abnormality determination condition is a condition that a process different from a process normally executed in the target device 153 is executed. For example, the predetermined abnormality determination condition is a condition that a frequency of executing a process in the target device 153 is less than a predetermined threshold value. For example, the predetermined threshold value is a value for sorting out traffic steadily generated in a target device from traffic generated when an abnormality occurs in the target device. Alternatively, for example, the predetermined threshold value is a value for discriminating between a frequency of file access steadily occurring in a target device and a frequency of file access occurring when an abnormality occurs in the target device. Further, the predetermined abnormality determination condition may be a condition that, based on list information previously storing information about an abnormal process, a process in log information matches information included in the list information. For example, the predetermined abnormality determination condition may be one or more of the following conditions indicated in a condition 1 to a condition 6.

Condition 1: a user having administrator authority executes a process not being normally executed (for example, a user having administrator authority allows unlimited access to a port number, or the user encrypts a plurality of files),

Condition 2: a communication with amount deviating from normal traffic amount occurs (for example, a communication is executed in a time period when a communication is rarely performed),

Condition 3: communications with time intervals of executing communication deviating from the normal time intervals occur (for example, communications with a communication frequency per time greater than a normal frequency occur),

Condition 4: a multicast communication to a plurality of target devices is executed although a multicast communication is normally not executed,

Condition 5: a process is executed in a time period different from a normal case (such as access to a server in a late-night period or access to a file in a late-night period), and

Condition 6: a communication is executed between two sockets for the first time (that is, log information is acquired for the first time as a combination of the sockets between which the communication is executed).

The predetermined abnormality determination condition is not limited to the examples described above. Further, processes described in Step S102 or later may be executed in reply to specifying an abnormal process by the abnormality determination unit 102. In this case, it achieves an advantageous effect that information about an abnormal process can be promptly acquired.

Next, the target information specification unit 103 reads process information (exemplified in FIG. 3) stored in the process information storage unit 108, communication information (exemplified in FIG. 4) stored in the communication information storage unit 109, file information (exemplified in FIG. 5) stored in the file information storage unit 110, and relevance information (exemplified in FIG. 6) stored in the relevance information storage unit 111. The target information specification unit 103 generates graph information (exemplified in FIG. 7) including a process that may affect an abnormal process selected by the abnormality determination unit 102 and a processing object that may affect the abnormal process (Step S102). Accordingly, the graph information is information conceptually indicating a process that may affect an abnormal process out of processes executed in a target device, or a processing object that may affect the abnormal process.

For example, the target information specification unit 103 specifies a process that may affect the abnormal process by specifying, in relevance information (or log information), a process being executed before a timing at which the abnormal process occurs and starting the abnormal process, a file accessed by the abnormal process, or a process including a socket used in a communication executed by the abnormal process. The target information specification unit 103 may further specify a process executed on the specified process, the specified socket, or the specified file, as a process that may affect the abnormal process. Furthermore, the target information specification unit 103 may specify a process that may affect the abnormal process by recursively executing the process described above.

For example, the target information specification unit 103 defines, as a vertex, each type of information being information indicating each process in the process information (exemplified in FIG. 3), socket information indicating each socket in the communication information (exemplified in FIG. 4), and information indicating each file in the file information (exemplified in FIG. 5), and gives a label related to each vertex to the vertex. Next, the target information specification unit 103 defines information indicating each relation in the relevance information (exemplified in FIG. 6) as an edge associated with the vertex. By the process as described above, the target information specification unit 103 generates graph information (exemplified in FIG. 7) conceptually representing a process executed in the target system including the target device. For example, when a process represented by the vertex 507 in FIG. 7 is an abnormal process, the target information specification unit 103 specifies a vertex reachable to the vertex 507 as a processing object that may affect the abnormal process. In the graph information exemplified in FIG. 7, the vertex 501 to the vertex 503, the vertex 505, the vertex 506, and the like are specified as vertices reachable to the vertex 507 by tracing directed edges in an opposite direction. As described above, one processing object is represented by use of two vertices being the vertex 502 and the vertex 506 for better recognizability in FIG. 7, and therefore the vertex 502 and the vertex 506 represent one vertex. Accordingly, the aforementioned vertices are specified for the vertex 507.

Further, when the process represented by the vertex 507 in FIG. 7 is an abnormal process, the target information specification unit 103 specifies edges passed through when searching for vertexes reachable to the vertex 507, as a process that may affect the abnormal process. In the graph information exemplified in FIG. 7, the edge 515, the edge 514, the edge 517, the edge 513, and the edge 511 are specified as the edges by tracing, in an opposite direction, directed edges passed through when specifying vertexes reachable to the vertex 507. An order of tracing directed edges in an opposite direction is not limited to the example described above.

In other words, for example, the target information specification unit 103 specifies log information (hereinafter referred to as “target log information”) including a processing object that may affect an abnormal process in log information acquired in the target system including the target device. Specifically, in the graph information exemplified in FIG. 7, the target information specification unit 103 specifies, as target log information, log information related to the edge 514 and the edge 515, log information related to the edge 514 and the edge 517, log information related to the edge 513, and log information related to the edge 511.

Next, for each edge in the graph information (exemplified in FIG. 7), the calculation unit 104 calculates a frequency of log information (or relevance information) represented by the edge for each combination of a process and a processing object. The calculation unit 104 calculates the frequency by calculating the number of edges between two vertices in the graph information (exemplified in FIG. 7). The calculation unit 104 calculates a score indicating an abnormality degree for occurrence of the relevance information (that is, a process is executed on a processing object), based on the frequency calculated for each combination of a process and a processing object (Step S103). The calculation unit 104 associates the score calculated for an edge with the edge (that is, gives the score as a label for the edge). In the process described in Step S103, for example, the calculation unit 104 calculates a frequency of occurrence of relevance information and calculates an abnormality degree, to be described later, based on the calculated frequency.

A process of calculating an abnormality degree by the calculation unit 104 will be described. An abnormality degree is information indicating a degree of abnormality of a process in relevance information. The process is a process executed on a processing object (file information (exemplified in FIG. 5), socket information in communication information (exemplified in FIG. 4), or process information (exemplified in FIG. 3)).

For convenience of description, it is assumed that a greater value of an abnormality degree represents a lower frequency of a process executed on the processing object. It is further assumed that a smaller value of an abnormality degree represents a higher frequency of a process executed on the processing object. The frequency may be a frequency in a certain period or a frequency in the certain period relative to a frequency in a specific period (that is, a relative frequency). The calculation unit 104 calculates a smaller value of an abnormality degree as a frequency of a process executed on a processing object is higher. Further, the calculation unit 104 calculates a greater value of an abnormality degree as a frequency of a process executed on a processing object is lower. The frequency is calculated for each process executed on a processing object.

A process of calculating a score will be specifically described. A communication process of the target device 153 transmitting information to the management device 151 is often executed repeatedly (that is, with a high frequency). In this case, the calculation unit 104 calculates a score indicating that an abnormality degree is low, as a score related to an edge associated with the communication process executed in the target device 153 and socket information indicating a socket passed through in the communication process. For example, when the communication process is executed N times (where N is a natural number) in a certain period, the calculation unit 104 may calculate a score “1÷N” for an edge corresponding to the communication process.

For example, when a process of a user having administrator authority performing a communication through a socket is highly likely to be an abnormal process, the calculation unit 104 calculates a high score for an edge associating a vertex representing the process with a vertex representing the socket. On the other hand, when a process of a plurality of target devices making transmissions to a single target device 153 is unlikely to be an abnormal process, the calculation unit 104 calculates a low score for an edge associating a vertex representing the process with a vertex representing a socket used in the transmission process.

Accordingly, graph information given with a score calculated by the calculation unit 104 as a label is information in which each process executed in each target device is associated with an abnormality degree indicating a degree of abnormality of each process as a label.

Accordingly, in Step S103, for log information (exemplified in FIG. 8, or relevance information) acquired in the target system including the target device, the calculation unit 104 calculates an abnormality degree indicating a degree of abnormality of the log information, based on a frequency of the log information.

After Step S103 described in FIG. 2, the selection unit 105 selects a part related to an abnormal process by deleting an edge with a score equal to or less than a predetermined threshold value in graph information in which an abnormality degree is labeled as the score. When a vertex that does not have a connecting edge exists, the selection unit 105 may delete the vertex from the graph information. Further, the selection unit 105 may delete a vertex (or an edge) that does not have a path to a vertex representing the process determined to be abnormal in Step S101.

In other words, by deleting an edge with a score equal to or less than the predetermined threshold value, the selection unit 105 specifies an edge (and a vertex connected to the edge) with a score greater than the predetermined threshold value from the graph information (exemplified in FIG. 7). In other words, the selection unit 105 selects log information (hereinafter referred to as “relevant log information”) with an abnormality degree satisfying a predetermined condition in log information that may affect an abnormal process executed in the target device 153 (Step S104). The predetermined condition indicates a condition for determining abnormal log information in relevant log information.

By deleting a vertex that does not have a connecting edge, the selection unit 105 selects information related to an abnormal process out of processing objects (that is, a process, a socket, or a file) related to the target device 153. Further, by deleting a vertex (or an edge) that does not have a path to a vertex determined to be abnormal, the selection unit 105 further selects an object being highly likely to be related to the abnormal process.

Accordingly, by selecting an edge with an abnormality degree greater than the predetermined threshold value in the graph information (that is, information schematically representing a process in the target device 153), the selection unit 105 selects relevant log information (or relevance information) with an abnormality degree satisfying the predetermined condition in the target log information. The selection unit 105 may select at least either type of information being a process included in the abnormal relevance information and a processing object.

Next, the display information generation unit 106 may generate display information indicating information selected by the selection unit 105. For example, the display information generation unit 106 generates display information by generating graph information representing a graph described referring to FIG. 7 for relevant log information selected by the selection unit 105. For example, the display information generation unit 106 may generate display information indicating relevant log information selected by the selection unit 105 in accordance with a mode similar to the relevance information exemplified in FIG. 6. The display information generation unit 106 may further generate display information indicating the relevant log information in accordance with a display mode depending on a processing object. Alternatively, the display information generation unit 106 may generate display information by selecting a part related to a process and a processing object included in the relevant log information selected by the selection unit 105 in graph information generated by the target information specification unit 103. The display information generation unit 106 displays a screen based on the generated display information on a display device (unillustrated).

In the aforementioned description, the target information specification unit 103 may generate graph information (exemplified in FIG. 7), based on process information (exemplified in FIG. 3) stored in the process information storage unit 108, communication information (exemplified in FIG. 4) stored in the communication information storage unit 109, file information (exemplified in FIG. 5) stored in the file information storage unit 110, and relevance information (exemplified in FIG. 6) stored in the relevance information storage unit 111. Alternatively, the target information specification unit 103 may generate the graph information (exemplified in FIG. 7), based on log information (exemplified in FIG. 8) acquired in the target system including the target device. Furthermore, the target information specification unit 103 may generate the graph information in reply to receipt of log information (exemplified in FIG. 8) from the target device 153. In this case, graph information (exemplified in FIG. 7) is generated in reply to receipt of log information (exemplified in FIG. 8), and therefore the information selection device 101 can provide information about an abnormality occurring in the target device 153 in an early stage.

Further, in the aforementioned description, the process of generating graph information, based on process information (exemplified in FIG. 3), communication information (exemplified in FIG. 4), file information (exemplified in FIG. 5), and relevance information (exemplified in FIG. 6), may be a process of updating graph information stored in the graph information storage unit 112, based on the aforementioned types of information. In this case, for example, the target information specification unit 103 reads the graph information stored in the graph information storage unit 112 in reply to receipt of log information (exemplified in FIG. 8) and based on the log information, executes an update process such as adding a vertex, deleting a vertex, adding an edge, or deleting an edge to/from the read graph information (exemplified in FIG. 7). The target information specification unit 103 stores the updated graph information into the graph information storage unit 112. By such an update process, the information selection device 101 can provide information about an abnormality occurring in the target device 153 in an early stage. The reason is that the update process requires a less processing amount compared with a process of generating graph information.

In summary, the information selection device 101 specifies a range of processes that may affect an abnormal process out of processes executed in a target system including a target device or a range of processing objects (target log information described above) that may affect the abnormal process. Furthermore, the information selection device 101 further selects an abnormal process or an abnormal processing object (abnormal log information described above) from the ranges, based on an abnormality degree. Accordingly, even when a range related to an abnormal process is wide, the information selection device 101 can narrow down the range that may affect the abnormal process.

Next, advantageous effects of the information selection device 101 according to the first example embodiment of the present invention will be described.

The information selection device 101 according to the first example embodiment can promptly acquire information about an event of interest. The reason is that the information selection device 101 specifies target log information that may affect an abnormal process in log information indicating processes executed in a target system including a target device and further specifies a process with a large value of a score representing an abnormality degree.

Further, by generating graph information including only a path to a process determined to be abnormal in Step S104, the information selection device 101 can more accurately calculate a range affected by an abnormal process. The reason is that the information selection device 101 selects a process determined to be abnormal in both of two abnormal determination processes as an abnormal process.

### Second Example Embodiment

Next, a second example embodiment of the present invention based on the aforementioned first example embodiment will be described.

In the following description, a part characteristic of the present example embodiment will be mainly described, and the same reference numeral is given to a configuration similar to that described in the aforementioned first example embodiment, thus omitting redundant description thereof.

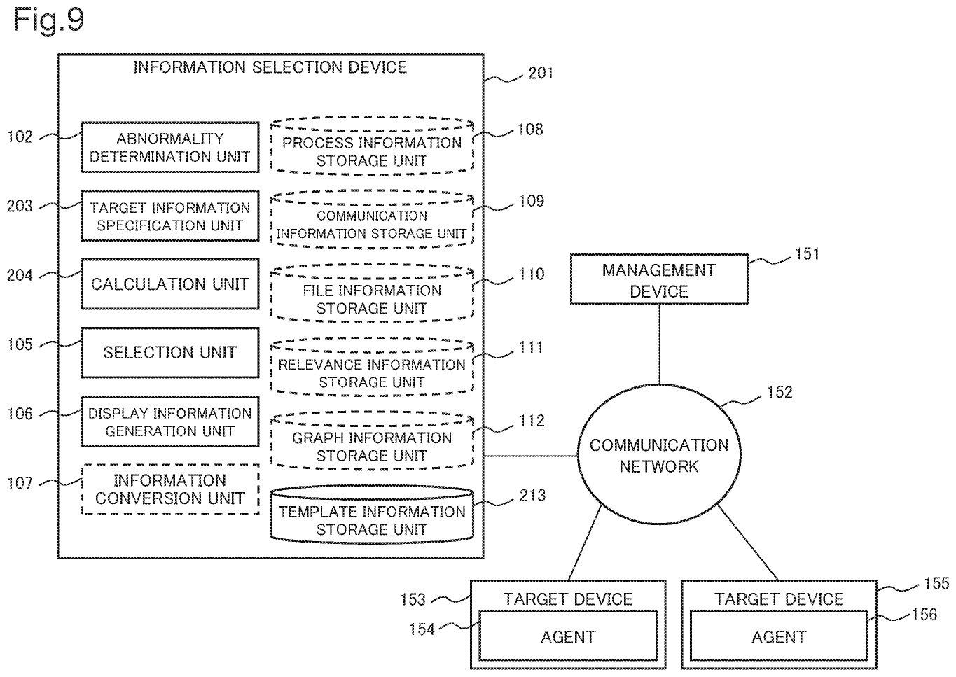

Referring to FIG. 9, a configuration of an information selection device 201 according to the second example embodiment of the present invention will be described in detail. FIG. 9 is a block diagram illustrating a configuration of the information selection device 201 according to the second example embodiment of the present invention.

The information selection device 201 according to the second example embodiment includes an abnormality determination unit (abnormality determiner) 102, a target information specification unit (target information specifier) 203, a calculation unit (calculator) 204, a selection unit (selector) 105, and a template information storage unit 213. The information selection device 201 may further include a display information generation unit (display information generator) 106 and an information conversion unit (information convertor) 107. The information selection device 201 may include a process information storage unit 108, a communication information storage unit 109, a file information storage unit 110, a relevance information storage unit 111, and a graph information storage unit 112.

The information selection device 201 may be communicably connected to a management device 151 or may be included in the management device 151, and may be communicably connected to a target device 153 through a communication network 152.

The template information storage unit 213 stores graph information as described referring to FIG. 7. For convenience of description, graph information stored in the template information storage unit 213 is hereinafter referred to as “template information.”

Each edge in template information is associated with a predetermined abnormality degree as a score. Specifically, in the template information, each edge in graph information is given a predetermined abnormality degree related to the edge as a label. The template information may be graph information in which each edge included in the graph information representing a process normally executed by a target device is given a low abnormality degree as a label. On the other hand, the template information may be graph information in which each edge included in the graph information representing a process being abnormal with respect to a target device (or a process determined to be abnormal) is given a high abnormality degree as a label. Accordingly, the template information is information in which a predetermined abnormality degree is given to each process in a combination of a plurality of processes. The template information is not limited to the example described above.

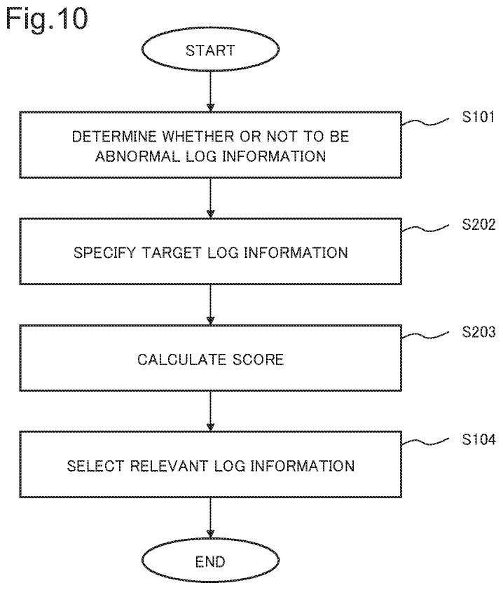

Next, referring to FIG. 10, a process in the information selection device 201 according to the second example embodiment of the present invention will be described in detail. FIG. 10 is a flowchart illustrating a process flow in the information selection device 201 according to the second example embodiment.

The abnormality determination unit 102 determines whether or not log information received from a target system is abnormal log information including an abnormal process satisfying a predetermined abnormality determination condition (Step S101).

The target information specification unit 203 specifies a process that may affect an abnormal process selected by the abnormality determination unit 102 and target log information including a processing object that may affect the abnormal process, in the log information received by the information selection device 201 (Step S202). For example, the target information specification unit 203 may specify target log information by executing a process similar to Step S102 described above in FIG. 2, based on graph information (exemplified in FIG. 7). Alternatively, the target information specification unit 203 may specify target log information by specifying relevance information associated with an abnormal process in the relevance information storage unit 111. The target information specification unit 203 may specify target log information by specifying a processing object included in relevance information associated with an abnormal process or relevance information associated with a process ID. In other words, the target information specification unit 203 may recursively specify target log information based on relevance information stored in the relevance information storage unit 111. The process in Step S202 is not limited to the example described above.

For convenience of description, it is assumed that the target information specification unit 203 generates graph information (exemplified in FIG. 7) and specifies target log information based on the generated graph information.

The calculation unit 204 calculates a score indicating an abnormality degree for edges included in the graph information generated by the target information specification unit 203 (Step S203). In Step S203, the calculation unit 204 reads template information stored in the template information storage unit 213 and specifies a part isomorphic to the template information in the graph information. However, the calculation unit 204 does not use the abnormality degree (score) given to edges in the process of specifying an isomorphic part. For example, the process of specifying an isomorphic part is executed based on a process name given to a vertex as a label, a port number given to a vertex as a label, a file name given to a vertex as a label, and a process content given to an edge as a label. The process of specifying an isomorphic part is not limited to the example described above.

When the graph information includes a part isomorphic to the template information, the calculation unit 204 gives a score included in a label given to corresponding edges in the template information to edges included in the isomorphic part. In other words, the calculation unit 204 calculates the same scores as scores included in the template information for edges in the isomorphic part. The calculation unit 204 may output information indicating that the graph information includes a part isomorphic to the template information or information indicating a part in the graph information isomorphic to the template information.

The calculation unit 204 calculates scores for edges by executing a process similar to Step S103 in FIG. 2 on a part other than the part isomorphic to the template information in the graph information. Accordingly, the calculation unit 204 calculates an abnormality degree related to target log information, based on template information (that is, a predetermined abnormality degree for a combination of a plurality of processes).

The selection unit 105 selects a part related to an abnormal process by deleting an edge with a score equal to or less than a predetermined threshold value in graph information labeled with an abnormality degree as the score. Since each edge in graph information represents a process and process information associated with one another in log information, the selection unit 105 selects relevant log information on the basis of an abnormality degree from the target log information (Step S104).

Next, advantageous effects of the information selection device 201 according to the second example embodiment of the present invention will be described.

The information selection device 201 according to the second example embodiment can promptly acquire information about an event of interest. The reason is similar to the reason described in the first example embodiment.

The information selection device 201 according to the second example embodiment can more accurately acquire information about an event of interest. The reason is that the selection unit 105 selects relevant log information from target log information based on template information indicating abnormality degrees for a plurality of processes.

Furthermore, the information selection device 201 according to the second example embodiment can provide information indicating that a target system is attacked by a plurality of processes. The reason is that when graph information includes a part isomorphic to template information, the calculation unit 204 outputs information indicating that the graph information includes a part isomorphic to the template information or information indicating a part isomorphic to the template information in the graph information. For example, when the template information represents a plurality of processes executed by malware, a user can recognize that a target system is attacked by the malware based on the information output by the calculation unit 204.

### Third Example Embodiment

Next, a third example embodiment of the present invention based on the aforementioned first example embodiment will be described.

In the following description, a part characteristic of the present example embodiment will be mainly described and the same reference numeral is given to a configuration similar to that described in the aforementioned first example embodiment, thus omitting redundant description thereof.

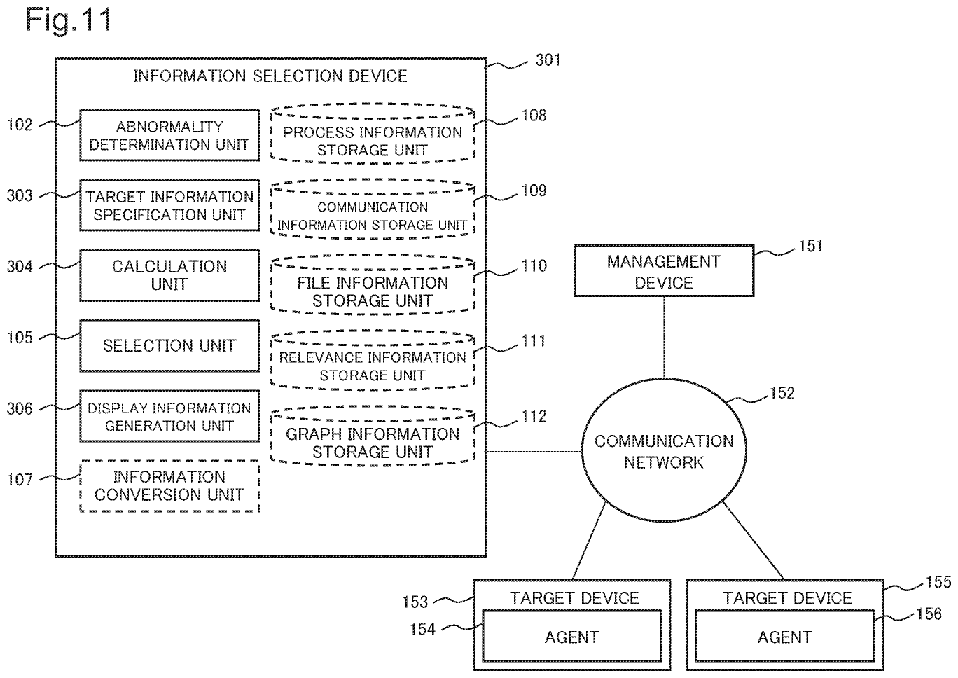

Referring to FIG. 11, a configuration of an information selection device 301 according to the third example embodiment of the present invention will be described in detail. FIG. 11 is a block diagram illustrating a configuration of the information selection device 301 according to the third example embodiment of the present invention.

The information selection device 301 according to the third example embodiment includes an abnormality determination unit (abnormality determiner) 102, a target information specification unit (target information specifier) 303, a calculation unit (calculator) 304, a selection unit (selector) 105, and a display information generation unit (display information generator) 306. The information selection device 301 may further include an information conversion unit (information converter) 107. The information selection device 301 may include a process information storage unit 108, a communication information storage unit 109, a file information storage unit 110, a relevance information storage unit 111, and a graph information storage unit 112.

The information selection device 301 may be communicably connected to a management device 151 or may be included in the management device 151, and may be communicably connected to a target device 153 through a communication network 152.

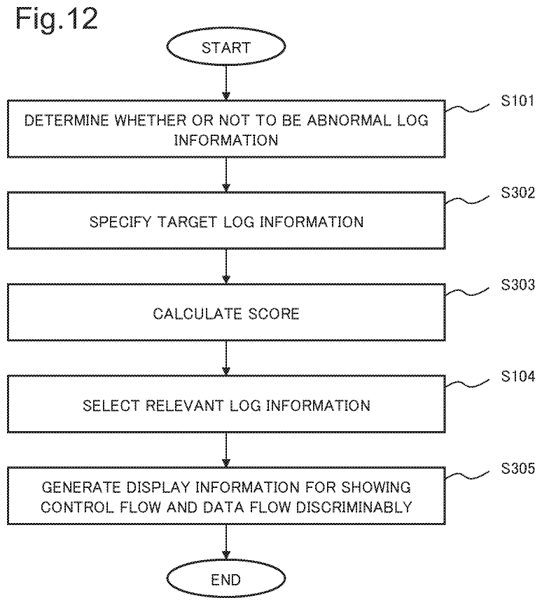

Next, referring to FIG. 12, a process in the information selection device 301 according to the third example embodiment of the present invention will be described in detail. FIG. 12 is a flowchart illustrating a process flow in the information selection device 301 according to the third example embodiment.

The abnormality determination unit 102 determines whether or not log information received from a target system is abnormal log information including an abnormal process satisfying a predetermined abnormality determination condition (Step S101).

The target information specification unit 303 specifies, in log information received by the information selection device 301, a process that may affect an abnormal process selected by the abnormality determination unit 102 and target log information including a processing object that may affect the abnormal process (Step S302). The process in Step S302 is a process similar to aforementioned Step S102 in FIG. 2 or Step S202 in FIG. 10.

Based on a frequency of target log information calculated for each combination of a process and a processing object, the calculation unit 304 calculates an abnormality degree indicating a degree of abnormality of the target log information (Step S303). The process in Step S303 is a process similar to Step S103 in FIG. 2 or Step S203 in FIG. 10.

The selection unit 105 selects, in the target log information, relevant log information with an abnormality degree calculated by the calculation unit 304 satisfying a predetermined condition (Step S104).

Next, the display information generation unit 306 generates display information for discriminably displaying a control flow and a data flow with respect to the relevant log information selected by the selection unit 105 (Step S305). Specifically, the display information generation unit 306 generates display information for performing display in accordance with a display mode allowing discrimination between a control flow and a data flow with respect to the relevant log information selected by the selection unit 105.

For example, the display mode allowing discrimination between a control flow and a data flow is a mode of displaying the two flows in different colors. When displaying relevant log information by use of a character, for example, the display information generation unit 306 generates display information for displaying a character representing a control flow and a character representing a data flow in different colors. When displaying relevant log information by use of graph information (exemplified in FIG. 7), for example, the display information generation unit 306 generates display information for displaying an arrow representing a control flow and an arrow representing a data flow in different colors (or in different lines (such as a solid line and a dotted line)). The display information generation unit 306 may generate display information allowing discrimination between an arrow representing a control flow and an arrow representing a data flow by, for example, adding icons different from each other. For example, the display mode allowing discrimination between a control flow and a data flow may be a mode of enclosing each of a part representing the control flow and a part representing a data flow in a frame. Alternatively, for example, the display mode allowing discrimination between a control flow and a data flow may be a mode of displaying background colors in the two parts in different colors. The display mode is not limited to the examples described above.

The display information generation unit 306 displays a screen based on the generated display information on a display device (unexemplified).

Next, advantageous effects of the information selection device 301 according to the third example embodiment of the present invention will be described.

The information selection device 301 according to the third example embodiment can promptly acquire information about an event of interest. The reason is similar to the reason described in the first example embodiment.

The information selection device 301 according to the third example embodiment can further provide display information allowing a user to readily identify a process flow (that is, a control flow). The reason is that a control flow and a data flow are displayed in different display modes.

### Fourth Example Embodiment

Next, a fourth example embodiment of the present invention will be described.

In the following description, the same reference numeral is given to a configuration similar to that described in each of the aforementioned example embodiments, thus omitting redundant description thereof.

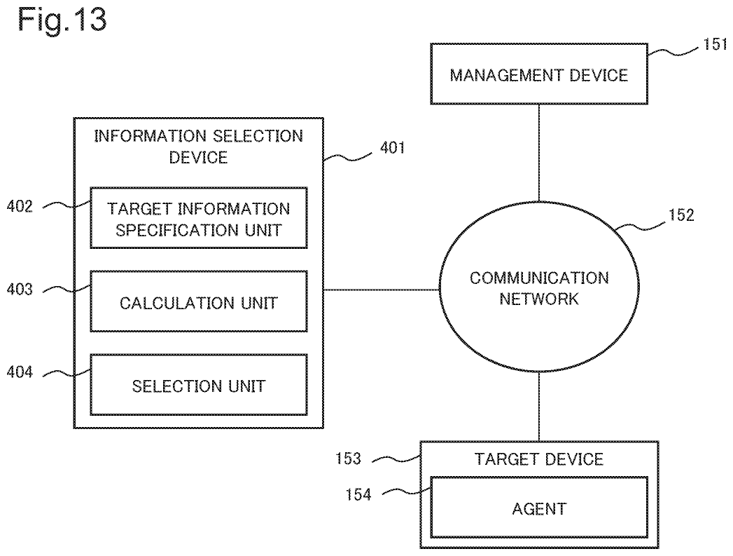

Referring to FIG. 13, a configuration of an information selection device 401 according to the fourth example embodiment of the present invention will be described in detail. FIG. 13 is a block diagram illustrating a configuration of the information selection device 401 according to the fourth example embodiment of the present invention.

The information selection device 401 according to the fourth example embodiment includes a target information specification unit (target information specifier) 402, a calculation unit (calculator) 403, and a selection unit (selector) 404.

The information selection device 401 may be communicably connected to a management device 151 or may be included in the management device 151, and may be communicably connected to a target device 153 through a communication network 152. For example, the target device 153 is an information processing device including an agent 154 monitoring a process executed in the own device. There may be a plurality of target devices 153. In this case, each agent generates log information indicating a content of a process executed in the target device including the agent and transmits the generated log information (exemplified in FIG. 8) to the management device 151 or the information selection device 401 through the communication network 152. Consequently, the information selection device 401 receives the log information acquired in a target system including the target device 153.

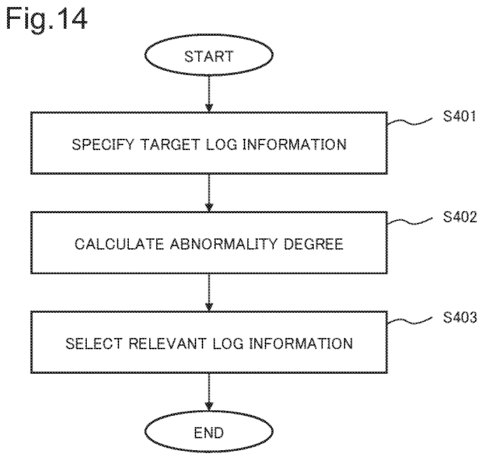

Next, referring to FIG. 14, a process in the information selection device 401 according to the fourth example embodiment of the present invention will be described in detail. FIG. 14 is a flowchart illustrating a process flow in the information selection device 401 according to the fourth example embodiment.

The information selection device 401 receives, from the agent 154, log information (exemplified in FIG. 8) indicating that a process is executed on a processing object in the target system including the target device 153.

The target information specification unit 402 specifies, in the log information, target log information including a processing object that may affect an abnormal process (Step S401). For example, the target information specification unit 402 specifies target log information by specifying, in the log information, log information associated with the abnormal process. The target information specification unit 402 may specify target log information by further specifying log information associated with a process included in the specified log information or a processing object included in the log information. Furthermore, the target information specification unit 402 may specify a process that may affect the abnormal process by recursively executing the process described above.

The calculation unit 403 calculates a frequency of target log information for each combination of a process and a processing object, and based on the calculated frequency, calculates an abnormality degree indicating a degree of abnormality of the target log information (Step S402). The process of calculating an abnormality degree based on a frequency is a process similar to the process described above in the first example embodiment to the third example embodiment.

The selection unit 404 selects relevant log information with an abnormality degree satisfying a predetermined condition in the target log information (Step S403). For example, the selection unit 404 selects relevant log information by selecting log information with an abnormality degree greater than a predetermined threshold value in the target log information.

The target information specification unit 402 can be provided by a function similar to the function of the target information specification unit 103 exemplified in FIG. 1, the target information specification unit 203 exemplified in FIG. 9, or the target information specification unit 303 exemplified in FIG. 11. The calculation unit 403 can be provided by a function similar to the function of the calculation unit 104 exemplified in FIG. 1, the calculation unit 204 exemplified in FIG. 9, or the calculation unit 304 exemplified in FIG. 11. The selection unit 404 can be provided by a function similar to the function of the selection unit 105 exemplified in FIG. 1, the selection unit 105 exemplified in FIG. 9, or the selection unit 105 exemplified in FIG. 11. Accordingly, the information selection device 401 can be provided by a function similar to the function of the information selection device 101 exemplified in FIG. 1, the information selection device 201 exemplified in FIG. 9, or the information selection device 301 exemplified in FIG. 11.

Next, an advantageous effect of the information selection device 401 according to the fourth example embodiment of the present invention will be described.

The information selection device 401 according to the fourth example embodiment can promptly acquire information about an event of interest. The reason is that the information selection device 401 specifies target log information that may affect an abnormal process in log information indicating a process executed in the target device 153 and further specifies a process with a large value of a score indicating an abnormality degree.

### Hardware Configuration Example

A configuration example of hardware resources that achieve an information selection device according to each example embodiment of the present invention using a computer processing device (information processing device, compute) will be described. However, the information selection device may be achieved using physically or functionally at least two calculation processing devices. Further, the information selection device may be achieved as a dedicated device.

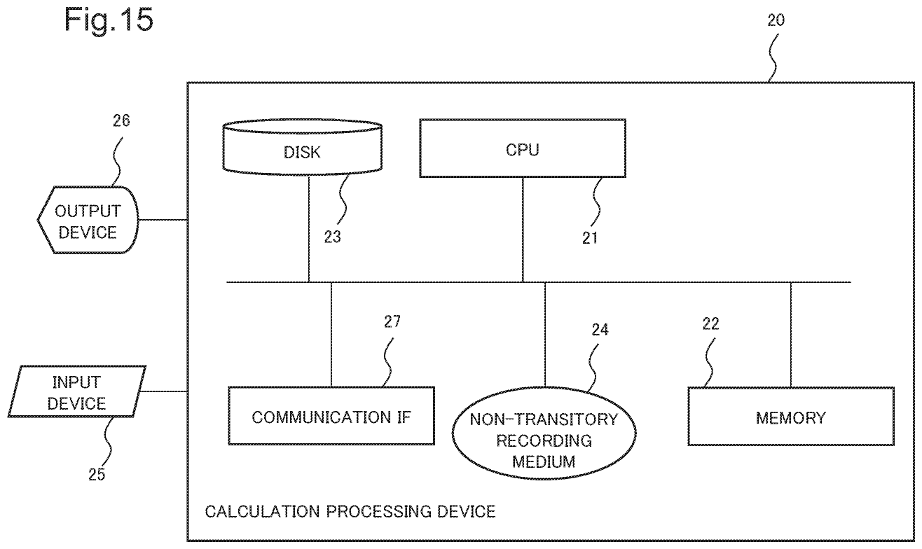

FIG. 15 is a block diagram schematically illustrating a hardware configuration of a calculation processing device capable of achieving an information selection device according to each example embodiment of the present invention. A calculation processing device 20 includes a central processing unit (CPU) 21, a memory 22, a disk (disc) 23, a non-transitory recording medium 24, and a communication interface (hereinafter, referred to as “communication I/F”) 27. The calculation processing device 20 may connect an input device 25 and an output device 26. The calculation processing device 20 can execute transmission/reception of information to/from another calculation processing device and a communication device via the communication I/F 27.

The non-transitory recording medium 24 is, for example, a computer-readable Compact Disc, Digital Versatile Disc. The non-transitory recording medium 24 may be Universal Serial Bus (USB) memory, Solid State Drive or the like. The non-transitory recording medium 24 allows a related program to be holdable and portable without power supply. The non-transitory recording medium 24 is not limited to the above-described media. Further, a related program can be carried via a communication network by way of the communication I/F 27 instead of the non-transitory recording medium 24.

In other words, the CPU 21 copies, on the memory 22, a software program (a computer program: hereinafter, referred to simply as a “program”) stored in the disk 23 when executing the program and executes arithmetic processing. The CPU 21 reads data necessary for program execution from the memory 22. When display is needed, the CPU 21 displays an output result on the output device 26. When a program is input from the outside, the CPU 21 reads the program from the input device 25. The CPU 21 interprets and executes an information selection program (FIG. 2, FIG. 10, FIG. 12, or FIG. 14) present on the memory 22 corresponding to a function (processing) indicated by each unit illustrated in FIG. 1, FIG. 9, FIG. 11, or FIG. 13 described above. The CPU 21 sequentially executes the processing described in each example embodiment of the present invention.

In other words, in such a case, it is conceivable that the present invention can also be made using the information selection program. Further, it is conceivable that the present invention can also be made using a computer-readable, non-transitory recording medium storing the information selection program.

The present invention has been described using the above-described example embodiments as example cases. However, the present invention is not limited to the above-described example embodiments. In other words, the present invention is applicable with various aspects that can be understood by those skilled in the art without departing from the scope of the present invention.

This application is based upon and claims the benefit of priority from Japanese patent application No. 2017-154627, filed on Aug. 9, 2017, the disclosure of which is incorporated herein in its entirety.

### REFERENCE SIGNS LIST

101 information selection device
102 abnormality determination unit
103 target information specification unit
104 calculation unit
105 selection unit
106 display information generation unit
107 information conversion unit
108 process information storage unit
109 communication information storage unit
110 file information storage unit
111 relevance information storage unit
112 graph information storage unit
151 management device
152 communication network
153 target device
154 agent
155 target device
156 agent
201 information selection device
203 target information specification unit
204 calculation unit
213 template information storage unit
301 information selection device
303 target information specification unit
304 calculation unit
306 display information generation unit
401 information selection device
402 target information specification unit
403 calculation unit
404 selection unit
20 calculation processing device
21 CPU
22 memory
23 disk (disc)
24 non-transitory recording medium
25 input device
26 output device
27 communication IF

1. An information selection device comprising:
a memory storing instructions; and
a processor connected to the memory and configured to execute the instructions to:
specify target log information among log information, the log information representing that a process is executed for a processing object in a target system, the target log information representing a processing object that may affect an abnormal process executed in the target system;
calculate a frequency of the target log information for each combination of the process with the processing object; and calculate an abnormality degree of the target log information based on the calculated frequency; and
select relevant log information with having the abnormality degree satisfying a condition for determining abnormal log information among the target log information.

2. The information selection device according to claim 1, wherein
the processing object is, at least, one of a process different from the process, a socket accessed in the process, and a file accessed in the process.

3. The information selection device according to claim 1, wherein
the processor is configured to execute the instructions to calculate the abnormality degree, the abnormality degree being higher toward lower frequency, the abnormality degree being lower toward higher frequency.

4. The information selection device according to claim 1, wherein
the processor is configured to execute the instructions to generate display information used in displaying the relevant log information in accordance with a mode depending on the processing object.

5. The information selection device according to claim 4, wherein
the processor is configured to execute the instructions to generate display information representing a graph which includes vertices and edges representing the relevance information and display a screen based on the generated display information on a display device, each of the vertices being defined for a processing object in the relevant log information and a process in the relevant log information, each of the edges representing an association between a vertex representing a process and a vertex representing a processing object.

6. The information selection device according to claim 4, wherein
the processor is configured to execute the instructions to generate graph information representing a graph that includes vertices and edges, each of the vertices being defined for a processing object in the target log information and a process in the relevant log information, each of the edges representing an association between a vertex representing a process and a vertex representing a processing object, and
set, to the display information, a part representing the relevant log information among the graph information generated by the target information specification means.

7. The information selection device according to claim 1, wherein
the processor is configured to execute the instructions to determine whether or not the log information received from the target system is abnormal log information including an abnormal process satisfying a predetermined abnormality determination condition and
specify the target log information in reply to determining that the log information is the abnormal log information by the abnormality determination means.

8. The information selection device according to claim 6, wherein
the processor is configured to execute the instructions to store template information representing a graph that includes edges associated with a predetermined abnormality degree and
calculate the predetermined abnormality degree for a part matching the template information among the graph information.

9. An information selection method, by an information processing device, comprising:
specifying target log information among log information, the log information representing that a process is executed for a processing object in a target system, the target log information representing a processing object that may affect an abnormal process executed in the target system;
calculating a frequency of the target log information for each combination of the process with the processing object;
calculating an abnormality degree of the target log information based on the calculated frequency; and
selecting relevant log information with having the abnormality degree satisfying a condition for determining abnormal log information among the target log information.

10. A non-transitory recording medium storing an information selection program causing a compute to achieve:
a target information specification function configured to specify target log information among log information, the log information representing that a process is executed for a processing object in a target system, the target log information representing a processing object that may affect an abnormal process executed in the target system;
a calculation function configured to calculate a frequency of the target log information for each combination of the process with the processing object, and calculate an abnormality degree of the target log information based on the calculated frequency; and
a selection function configured to select relevant log information with having the abnormality degree satisfying a condition for determining abnormal log information among the target log information.
